(19) United States
(12) Patent Application Publication
(10) Pub. No.: US 2011/0220655 A1
(43) Pub. Date: Sep. 15, 2011

(54) TRASH CAN

(75) Inventors: Frank Yang, Rancho Palos Verdes, CA (US); Tzu-Hao Wei, Hacienda Heights, CA (US); Joseph Sandor, Santa Ana Heights, CA (US)

(73) Assignee: SIMPLEHUMAN, LLC, Torrance, CA (US)

(21) Appl. No.: 13/047,662

(22) Filed: Mar. 14, 2011

Related U.S. Application Data
(60) Provisional application No. 61/313,679, filed on Mar. 12, 2010.

(51) Int. Cl. B65F 1/06; B65F 1/16; B65D 43/26; B65D 55/02

(52) U.S. Cl. 220/495.09; 220/263; 220/908; 220/694

(57) ABSTRACT

A trashcan with a lid can include a pedal bar and a pedal protector. The pedal protector can be flipped and/or rotated, such that the pedal protector can be moved adjacent the pedal (e.g. below the pedal) or away from the pedal bar. The trashcan with a lid can further include at least one notch and/or divider to allow for insertion of more than one trash bag into the body of the trashcan.

### RELATED APPLICATIONS

This application claims benefit under 35 U.S.C. §119(e) to U.S. Provisional Patent Application No. 61/313,679, filed Mar. 12, 2010, which is incorporated in its entirety by reference herein. U.S. Patent Application No. 60/906,071, filed Mar. 9, 2007, and U.S. patent application Ser. No. 12/045,641, filed Mar. 10, 2008, are each incorporated in their entireties by reference herein.

### BACKGROUND OF THE INVENTIONS

1. Field of the Inventions

The present inventions are directed to trashcans.

2. Description of the Related Art

Receptacles and other devices having lids or doors are used in a variety of different settings. For example, in both residential and commercial settings, trashcans and other devices often have lids or doors for protecting or preventing the escape of the contents of the receptacle. In the context of trashcans, some trashcans include lids or doors to prevent odors from escaping and to hide the trash within the receptacle from view. Additionally, the lid of a trashcan helps prevent contamination from escaping from the receptacle.

Recently, trashcans with rotary-type motion dampers for slowing the motion of the lids have become commercially available. More specifically, these rotary dampening mechanisms are connected to the lids of the trashcans so as to slow the closing movement of the lids. As such, the trashcan is more aesthetically pleasing because the lid closes slowly, thereby preventing a loud slamming noise when the lid is moved to a closing position.

Further, these types of trashcans often are pedal-actuated, i.e., they include a foot pedal which is connected to the lid for moving the lid toward the open position. The rotary mechanisms are connected to the internal linkage connecting the foot pedal to the lid so as to slow the closing movement of the lid.

### SUMMARY OF THE INVENTIONS

An aspect of at least one of the embodiments disclosed herein includes the realization that including a pivotable pedal protector can in some embodiments not only provide a stabilizing force to prevent the trash can from tipping over, but can also facilitate stacking of trashcans for shipping and/or storage. Another aspect of at least one of the embodiments disclosed herein includes the realization that including a notch or notches on the body or liner of a trashcan can facilitate insertion of more than one trash bag. Furthermore, providing a divider can further help separate a trash can, and facilitate more than one trash bag inside the trash can.

Thus, in accordance with an embodiment, a trashcan can comprise a body defining an interior cavity configured to receive trash, the trash can body having at least one upper opening through which trash can be inserted into the interior cavity, a lid pivotally attached to the trash can body so as to move between opened position and closed positions, a lid actuating system comprising a pedal and at least one linkage connecting the pedal with the lid, such that movement of the pedal causes opening and closing movement of the lid, a lid latch supported by the lid, the lid latch comprising a slidable member mounted so as to be slidable relative to the lid, the lid latch being slidable from a first position in which the lid latch engages a ledge of the trash can body so as to lock the lid in a closed position and a second position in which the lid latch does not engage the ledge of the trash can body, a mounting platform connected to the body, a damping mechanism connected to the mounting platform and to at least one of the linkages and pedal, the damping mechanism configured to dampen movement of the lid in at least one of an opening and closing motion, at least one notch along the body for insertion of a trash bag, a plurality of divider holding components located along the interior cavity, a divider connected to the plurality of divider components, the divider dividing the interior cavity into a plurality of cavities for receiving trash, and a pedal protector pivotably coupled to the body, the pedal protector configured to pivot from a first position near the pedal to a second position away from the pedal.

In accordance with another embodiment, a trashcan can comprise a body defining an interior cavity configured to receive trash, the trashcan body having at least one upper opening through which trash can be inserted into the interior cavity, a lid pivotally attached to the trashcan body so as to move between opened position and closed positions, a lid actuating system comprising a pedal and at least one linkage connecting the pedal with the lid, such that movement of the pedal causes opening and closing movement of the lid, at least one notch along the body for insertion of a trash bag, a plurality of divider holding components located along the interior cavity, and a divider connected to the plurality of divider components, the divider dividing the interior cavity into a plurality of cavities for receiving trash, the divider comprising a plurality of divider connection members having elongate members with I-beam configurations configured to be received within the divider holding components.

In accordance with yet another embodiment, a trashcan can comprise a body defining an interior cavity configured to receive trash, the trashcan body having at least one upper opening through which trash can be inserted into the interior cavity, a lid pivotally attached to the trashcan body so as to move between opened position and closed positions, a lid actuating system comprising a pedal and at least one linkage connecting the pedal with the lid, such that movement of the pedal causes opening and closing movement of the lid, and a pedal protector pivotably attached to the body.

### BRIEF DESCRIPTION OF THE DRAWINGS

These and other features and advantages of the present embodiments will become more apparent upon reading the following detailed description and with reference to the accompanying drawings of the embodiments, in which:

FIG. 1 is a right perspective view of a step trashcan in accordance with an embodiment;

FIG. 2 is a left side view thereof;

FIG. 3 is a front view thereof;

FIG. 4 is a right side view thereof;

FIG. 5 is a rear view thereof;

FIG. 6 is a top plan view thereof;

FIG. 7 is a bottom plan view thereof.

FIG. 8 is a sectional view taken along line 8-8 in FIG. 6.

FIG. 9A is a detail sectional view of the step trashcan taken along line 9A-9A in FIG. 9B with a lid latch in an unlocked position;

FIG. 9B is a top plan view of the lid with the lid latch in the unlocked position;

FIG. 10A is a detail sectional view of the step trashcan taken along line 10A-10A in FIG. 10B, with the lid latch in a locked position;

FIG. 10B is a top plan view of the lid with the lid latch in the locked position.

FIG. 11 is a plan view of the underside of the lid with the latch in the unlocked position.

FIG. 12 is a plan view of the underside of the lid with the lid latch in the locked position.

FIG. 13 is a top perspective view of the lid with the lid latch in the unlocked position.

FIG. 14 is a top perspective view of the lid with the lid latch in the locked position.

FIG. 15 is a front perspective view of the step trashcan with the lid open, showing the underside of the lid with the lid latch in the unlocked position.

FIG. 16 is a front perspective view of the step trashcan with the lid open, showing the underside of the lid with the lid latch in the locked position.

FIG. 17 is a left perspective view of the trashcan, with the body and wheels removed.

FIG. 18 is a top, left perspective view of a trash can in accordance with another embodiment.

FIG. 19 is a top, left perspective view of the trash can of FIG. 18, with the lid removed.

FIG. 20 is a partial, enlarged view of the inside of a front of the trashcan of FIG. 18.

FIG. 21 is a partial, enlarged view of the inside of a back of the trashcan of FIG. 18.

FIG. 22 is a top, left perspective view of the trashcan of FIG. 18, with a divider positioned inside.

FIG. 23 is a perspective view of the divider from FIG. 22.

FIGS. 24 and 25 are partial, enlarged perspective views of the divider from FIG. 22.

FIG. 26 is a partial, enlarged view of the front of the trashcan of FIG. 18, with the divider positioned inside.

FIG. 27 is a left elevational cross sectional view of the trash can of FIG. 18, showing the divider positioned inside.

FIG. 28 is a bottom, left perspective view of the trash can of FIG. 18, showing a pedal protector.

FIGS. 29-32 are enlarged, partial perspective views of the bottom of the trash can of FIG. 18, showing the pedal protector.

### DETAILED DESCRIPTION OF THE PREFERRED EMBODIMENTS

The inventions disclosed herein are disclosed in the context of a trashcan because they have particular utility in this context. However, the inventions disclosed herein can be used in other contexts as well. Further, the inventions are described herein in reference to various embodiments and drawings. It will be appreciated by those skilled in the art that variations and improvements may be accomplished in view of these teachings without deviating from the scope and spirit of the invention. By way of illustration, the present inventions are described in reference to a step-type trash container, or a step trashcan of the kind typically used in kitchens, for example. Other types of trash containers, with pivoted lids or removable lids can be used in connection with the present inventions.

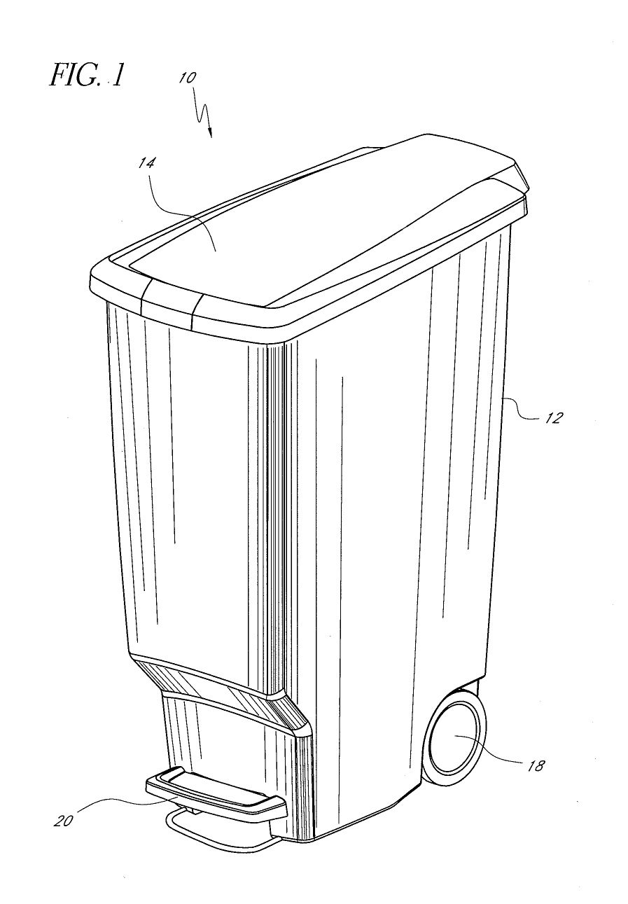

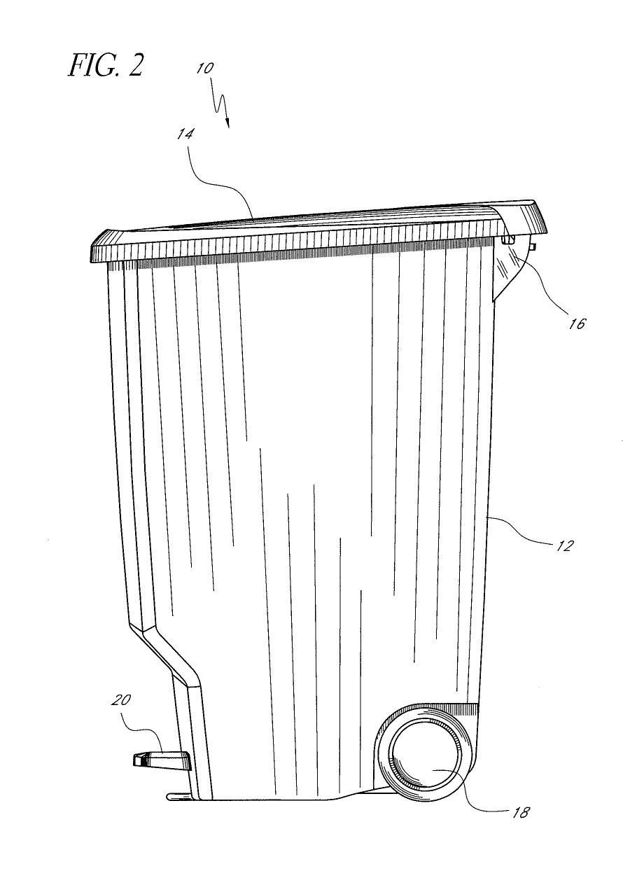

With reference to FIGS. 1-3, a step trashcan 10 can generally have a body 12 defining an interior cavity configured to receive trash, and a lid 14 pivotally supported relative to the body 12. For example, the lid 14 can be hinged to a rear top edge of the body 12 by a hinge member 16 as shown in FIG. 2. A pair of wheels 18, provided along the bottom of the trashcan 10, can be provided to facilitate moving the step trashcan 10 along a rolling surface.

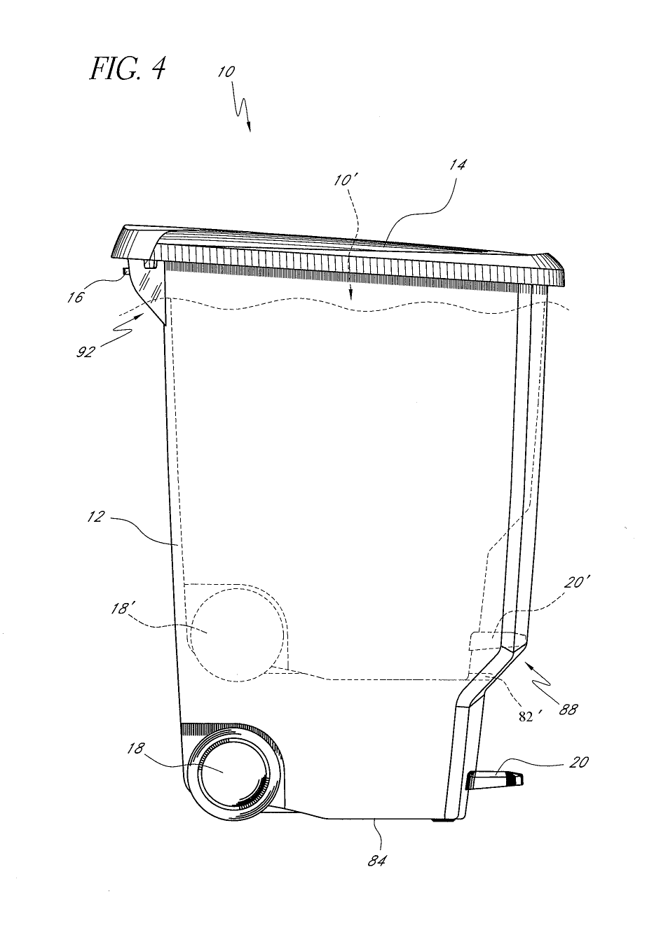

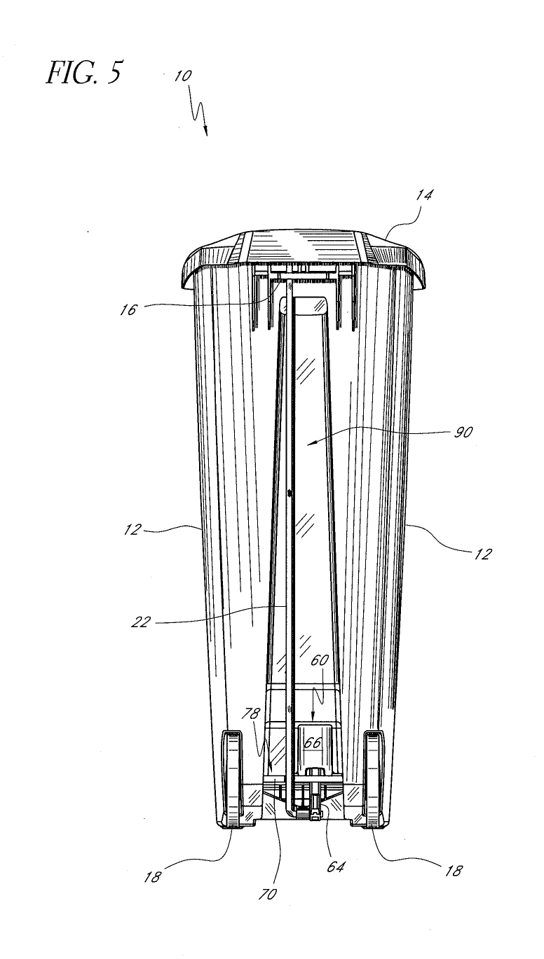

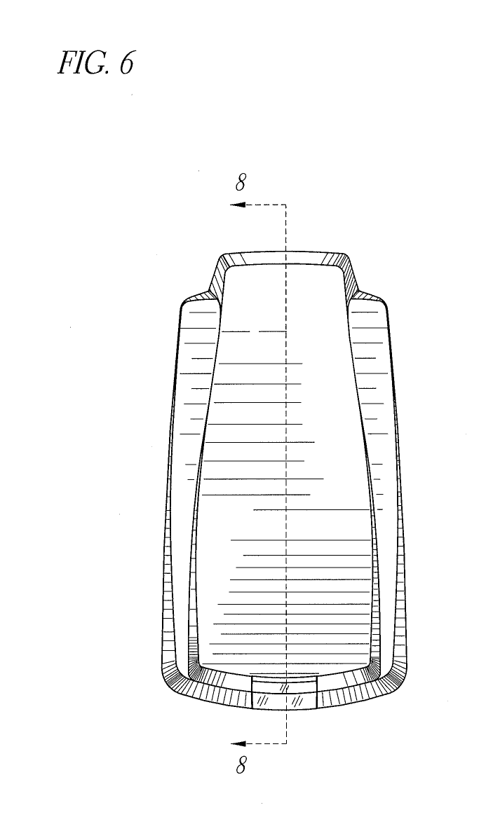

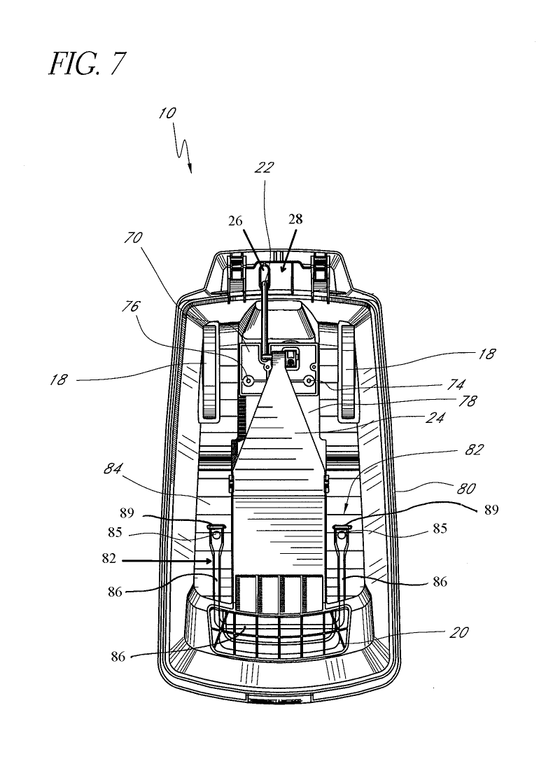

With reference to FIGS. 4, 5, and 7, a lid actuator system (e.g. opening mechanism) can be provided along the top of the step trashcan 10 to activate pivotal opening of the lid 14. The lid actuator system can include a foot piece (or “pedal”) 20. The pedal 20 can be located, for example, near a lower front portion of the body 12, though other locations are also possible. The lid actuator system can include linkages 22 (see FIGS. 5 and 7) and a lever member 24 (see FIG. 7), that can cooperate to move the lid 14 from a closed to an open position. In some embodiments, and with continued reference to FIG. 7, at least one linkage 22 can extend through an opening 26 along a back portion 28 of the trashcan 10. Other lid actuator systems known in the art can be deployed without departing from the scope and spirit of the present inventions.

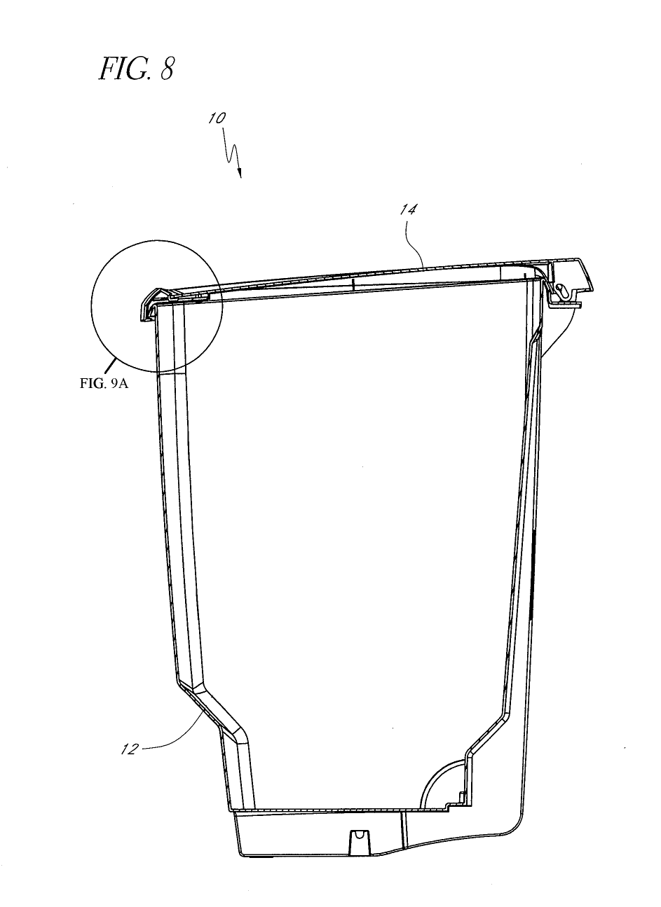

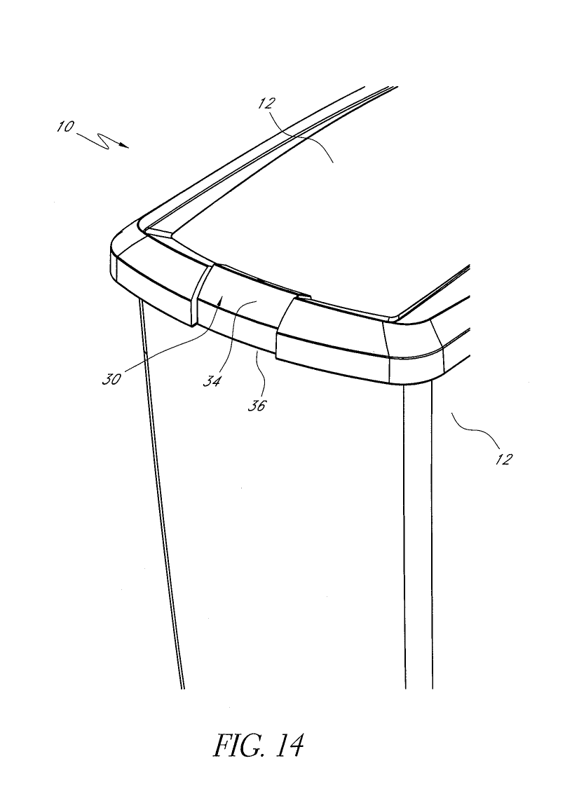

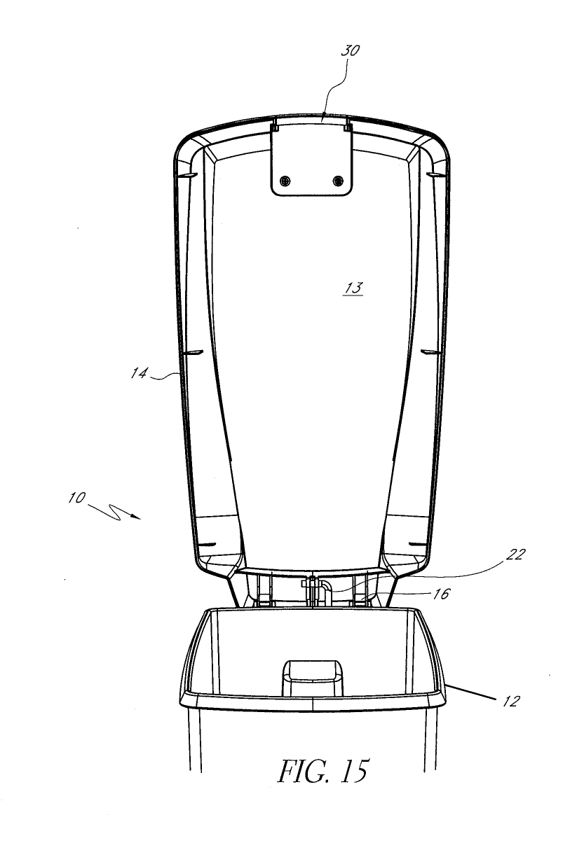

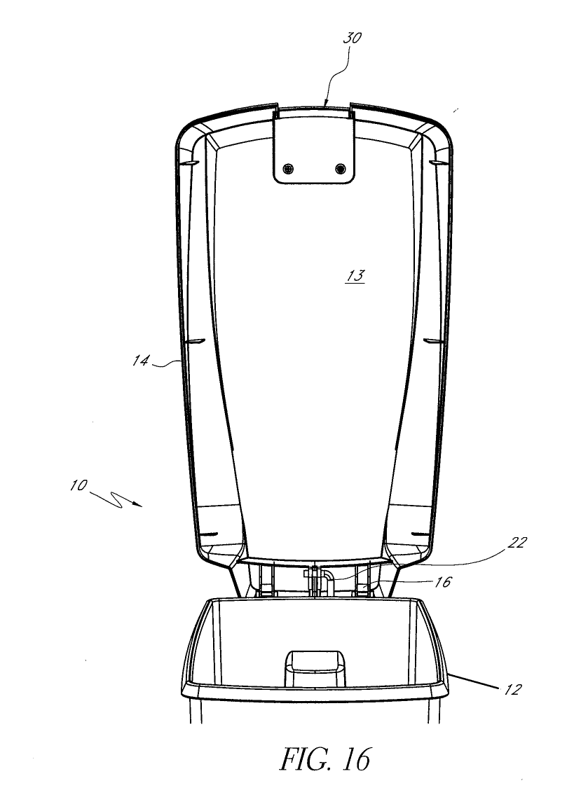

In some embodiments, and with reference to FIGS. 8-16, the lid 14 can include a lid latch 30, which can for example be integrated into or self-contained in the lid 14 (e.g. as opposed to a separate external locking piece for the lid). In some embodiments, the lid latch 30 can be configured to slide with respect to an edge of the opening of the body 12 from an unlocked position to a locked position. A sliding support interface between the lid latch 30 and the lid 14 can be provided with structures (e.g., indent and complementary locking tabs) that positively index the lid latch 30 in the locked and unlocked positions. However, other configurations can also be used.

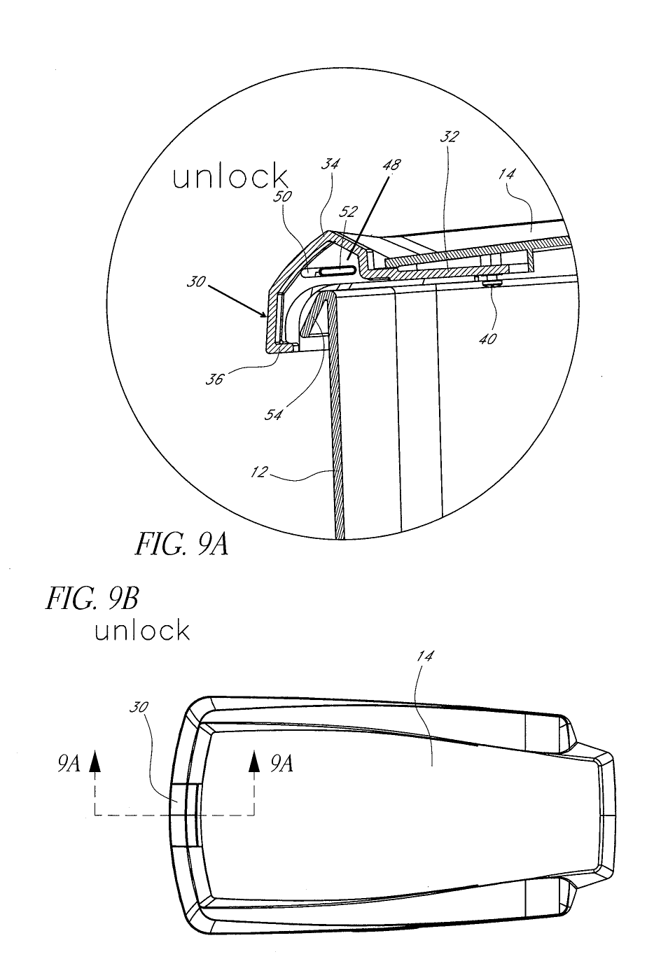

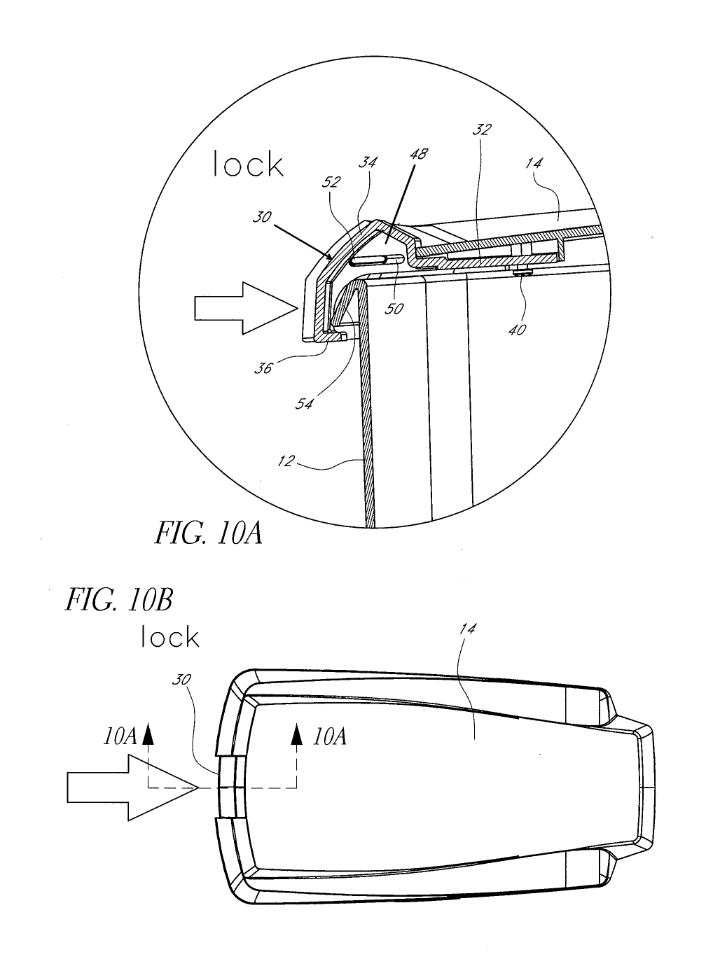

FIGS. 9, 11, 13 and 15 illustrate an embodiment of the lid latch 30 in the opened/unlocked position, and FIGS. 10, 12, 14 and 16 illustrate the lid latch 30 in the closed/locked position. FIGS. 9-16 overall illustrate various views of the sliding movements of the lid latch 30 with respect to the body 12, from the open/unlocked position to a closed/locked position.

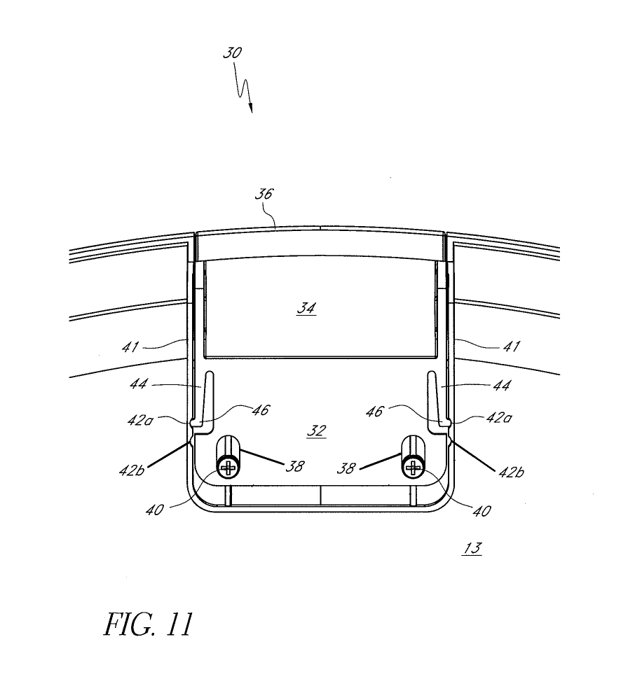

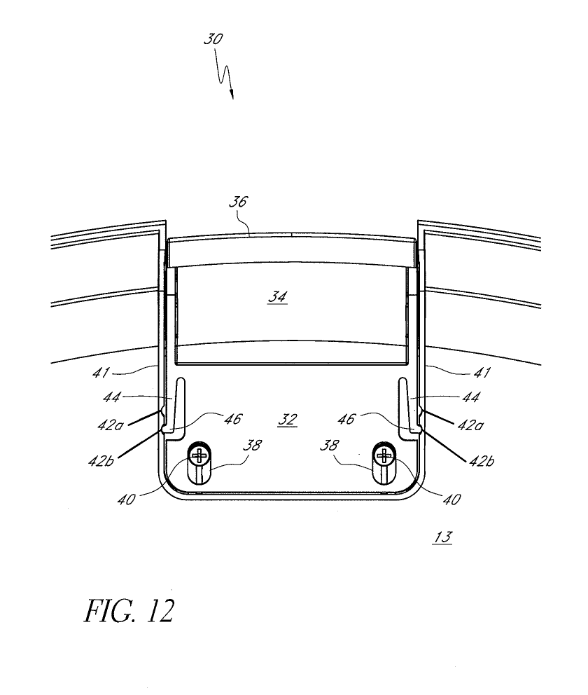

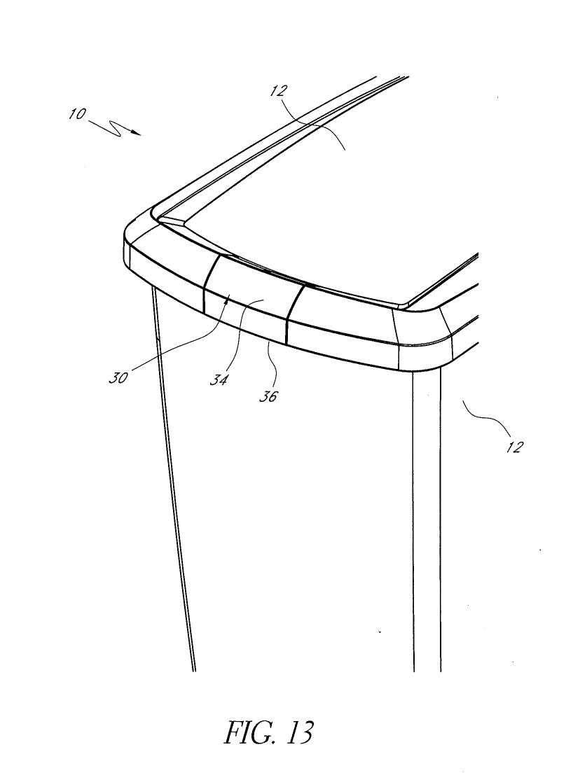

Referring to FIGS. 9A, 10A, and 11-14, in some embodiments the lid latch 30 can comprise a plate section 32, a bent section 34, and a lip 36. The bent section 34 can be exposed externally, as illustrated in FIG. 13, and can have a profile that is generally flush with the profile of the adjacent structure of the lid 14 when in the unlocked or locked position, thereby providing an aesthetically pleasing and appealing structure. With reference to FIGS. 11 and 12, the plate section 32 can be provided with two slotted holes 38. The plate section 32 can be slidably attached to an underside 13 of the lid 14 by two retaining screws 40 anchored to the underside 13 of the lid 14, and extending at least in part through the two slotted holes 38.

The slotted holes 38 can be sized to allow the screws 40 to slide relatively within the slotted holes 38, thereby allowing the plate section 32 to slide relative to the lid 14, from the opened/unlocked position shown in FIG. 11 to the closed/locked position shown in FIG. 12. Further, and with reference to FIGS. 9A and 10A, in some embodiments the bent sections 34 can include sides 48, with slotted holes 50. The slotted holes 50 can be provided to receive a stub 52 anchored along the lid 14. The slotted holes 50 can be sized to allow the stubs 52 to slide relatively within the slotted holes 50, thereby further supporting sliding movement of the lid latch 30.

With reference to FIGS. 11 and 12, indentations 42a and 42b can be provided on along the lid 14. The plate section 32 of the lid latch 30 can have at each side extending spring tabs 44 that are biased outward away from the plate section 32. The tabs 44 can be provided with a detent with a rounded tip 46 that protrudes and can be received in the indentations 42a, 42b.

As the plate section 32 slides from an opened/unlock position to a closed/lock position, the tips 46 can move from lodged positions in indentations 42a as shown in FIG. 11, to lodged positions in indentation 42b as shown in FIG. 12, thereby indexing the lid latch 30 from one position to another. The spring bias in the tabs 44 is configured such that sufficient force is applied to lodge the tips 46 in the indentations 42a and 42b at the respective positions, to securely hold the lid latch 30 in place at the respective positions.

With reference to FIGS. 9A and 10A, in some embodiments, the periphery of the opening of the body 12 can have an outwardly extending flange or ledge 54. In the open/unlocked position shown in FIG. 9A, the lip 36 of the lid latch 30 can be released (i.e., does not catch) from the ledge 54, allowing the lid 14 to be opened with respect to the body 12. In the closed/locked position shown in FIG. 10A, the lip 36 of the latch 30 can be latched onto (i.e., catch) the ledge 54, thereby locking the lid 14 against the body 12. In some embodiments, the ledge 54 can be formed from an upper portion of a side wall of the body 12. In some embodiments, the ledge 54 can extend from the internal cavity defined by the body 12. Additionally, stiffening ribs (not shown) can extend between the ledge 54 and an outer surface of the body 12 to enhance the stiffness of the ledge 54.

While the above described embodiments are directed to deployment of the lid latch 30 in a step-type trash container having a pivoted lid, it is understood that the lid latch 30 can be used in a trash container that has a lid 14 that is not attached to the container body, such as a lid 14 that is removed or separated from the container body 12 when opening the lid 14.

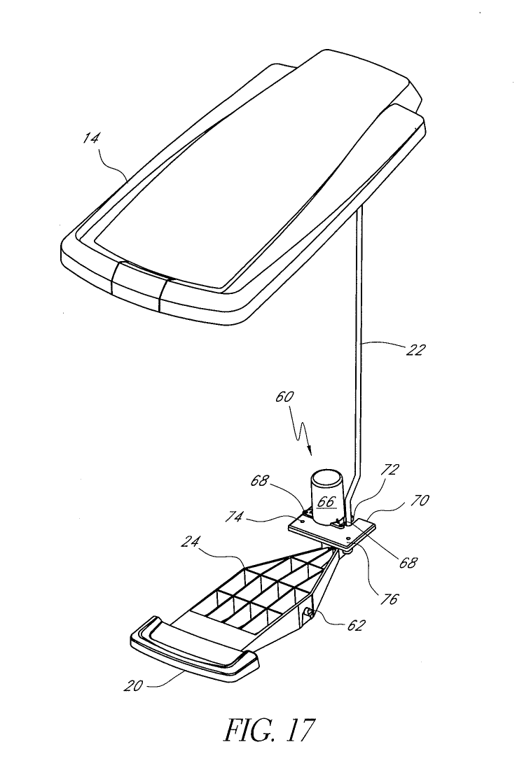

With reference to FIGS. 5 and 17, in some embodiments the trashcan 10 can include a damping mechanism 60 configured to dampen the movement of the lid 14. For example, and with reference to FIG. 17, a damping mechanism 60 can be disposed at an end of the lever member 24 connecting the pedal 20 with the linkage 22. In some embodiments, the linkage 22 can comprise a lifting rod. The lifting rod 22 can be connected to an end of the lever member 24 that is opposite the pedal 20. As such, when a user depresses the pedal 20, the lever member 24 can pivot about a pivot member 62, thereby causing the lifting rod 22 to rise and open the lid 14.

As shown in FIGS. 5 and 17, the damping mechanism 60 can have a piston rod portion 64 and a cylinder portion 66. The construction and operation of this type of damping mechanism is disclosed in U.S. Patent Publication No. 2007/0012699, the entire contents of which is incorporated herein by reference.

In some embodiments, the lower end of the piston rod 64 can be connected to an end of the lever member 24 that is opposite the pedal 20. In other embodiments, the lower end of the piston rod 64 can be connected to an end of the lifting rod 22. When a user steps on the pedal 20, the end of the lever member 24 connected to the lifting rod 22 can rise, thereby opening the lid 14 by raising the lifting rod 22, and causing the piston rod 64 to rise. The damping mechanism 60 can dampen the movement of the lid toward the closed position by slowing the downward movement of the lifting rod 22 and lid 14. Alternatively, in some embodiments the damping mechanism 60 can dampen upward movement of the lifting rod 22 and lid 14.

Due to the damping provided by the damping mechanism 60, the damping mechanism 60 itself can experience significant loads. Thus, and with continued reference to FIG. 17, the cylinder portion 66 can include a plurality of flanges 68. The flanges 68 can be used to secure and mount the cylinder portion 66 in a fixed position relative to the body 12.

Often, the bodies of trashcan are made from softer, more malleable plastics, such as high impact polypropylene or other relatively softer plastic materials. However, other hardnesses can also be used. Thus, because these types of plastics are soft, if the cylinder portion 66 is attached directly to the body 12, the cylinder portion 66 is more likely to move or twist under the loads generated during operation of the pedal 20 and the closing movement of the lid 14. Additionally, such softer materials can fail from fatigue.

Thus, to provide a more secure and reliable attachment of the damping mechanism 60 to the body 12, the trashcan 10 can include a mounting platform 70, as seen for example in FIG. 17. In some embodiments, the mounting platform 70 can be made from material that is harder than the material used to make the body 12. For example, but without limitation, the mounting platform 70 can be made from Acrylonitrile Butadiene Styrene (ABS) plastic, or other materials.

With reference to FIG. 17, the mounting platform 70 can include an opening 72 such as a groove or an aperture configured to allow the lifting rod 22 to freely move up and down as the user steps on or releases the pedal 20. The mounting platform 70 can be attached to the cylinder portion 66 using the flanges 68 and any type of fastener.

The mounting platform 70 can be connected to the body 12 in any known manner. In some environments, the mounting platform 70 can include apertures 74, 76 through which threaded fasteners can extend to attach the platform 70 to the body 12.

With reference to FIG. 7, in some embodiments, the body 12 can include a downwardly facing surface 78. The mounting platform 70 can be attached to the downwardly facing surface 78, for example, with fasteners extending through the holes 74, 76. Additionally, the mounting platform 70 can also be glued to the lower surface 78.

With the mounting platform 70 attached to the downwardly facing surface 78, when the pedal 20 is depressed and the lifting rod 22 and the piston rod 64 are raised, all of the associated forces imparted to the mounting platform 70 can be transferred to the downwardly facing surface. 78 of the body 12. This provides the attachment of the damping mechanism 60 to the body 12 with enhanced strength that can better withstand the forces generated because a user can step on the pedal 20 with all of their weight. Thus, the upward movement of the piston rod 64 can be quite fast, and thus can cause significant forces on the mounting member 70.

When the pedal 20 is released, thereby allowing the lid 14 to close, the lifting rod 22 can fall along with the piston rod 64. The structure(s) within the cylinder member 66 can slow the movement and also impart loads onto the mounting platform 70. These loads can be transferred to the body 12 through the fasteners and/or any other attachment means for attaching the mounting platform 70 to the body 12.

In some embodiments where the mounting platform 70 is made from a harder material than that used for the body 12, the mounting platform 70 may not deform as greatly as it would if it were made from the same, or softer, material as that of body 12. Thus, the damping mechanism 60 can perform more reliably and consistently when used in conjunction with the mounting platform 70.

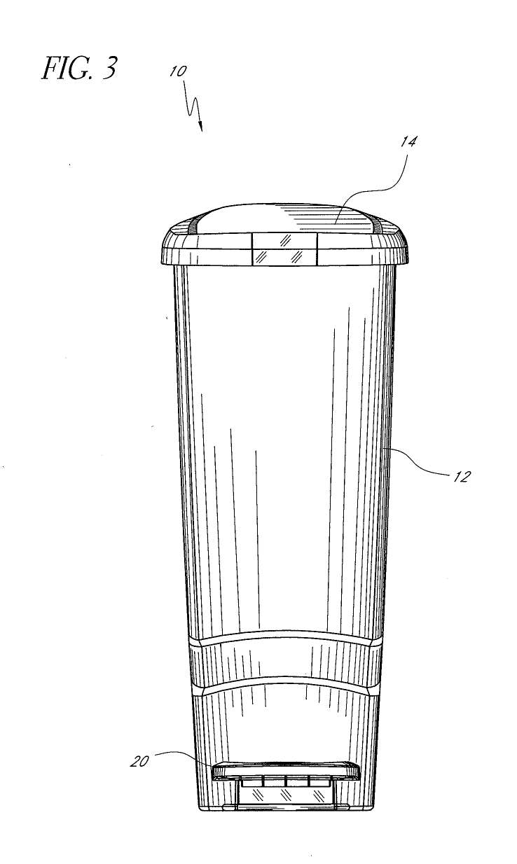

With reference to FIGS. 3 and 4, in some embodiments the trashcan 10 can be configured to be stackable. For example, the trashcan body 12 can have a tapered shape, expanding outwardly and upwardly. As shown in FIGS. 3 and 4, the outer surfaces of the body 12 can be tapered outwardly and upwardly. As such, with the lid 14 removed, a plurality of the trashcans 10 can be stacked one within another.

With reference to FIG. 7, the trashcan 10 can be configured such that the features near the bottom of the trashcan 10 fall entirely within a footprint of the upper portion of a side wall forming the body 12. For example, as shown in FIG. 7, the pedal 20 and the wheels 18, as seen in a bottom plan view, can fall entirely within a periphery 80 defined by an upper portion of a side wall forming the body 12. As such, when one trashcan 10 is stacked within another, the pedal 20 and the wheels 18 can fit within the cavity of another trashcan.

With continued reference to FIG. 7, in some embodiments the trashcan 10 can include a pedal protector, such as pedal protector 82 (shown transparently in FIG. 7). The pedal protector 82 can be attached to a lower surface 84 of the body 12. In some embodiments, the pedal protector 82 can be fixed to the lower surface 84 with threaded fasteners, such as screws, extending through apertures 85 in the pedal protector 82. However, other devices can also be used for fixing the pedal protector 82 to the lower surface 84.

In some embodiments, the pedal protector 82 can serve as a stabilizing structure that provides stability to the trash can 10 and inhibits or prevents the trash can 10 from easily being tipped over. In some embodiments the pedal protector 82 can inhibit or prevent the pedal 20 from rubbing against or contacting a ground surface, and being worn or damaged.

The pedal protector 82 can be in the form of a generally U-shaped bar having arms 86, though other shapes and configurations are also possible. The lower surface 84 of trashcan 10 can include a recessed channel (not shown) into which one or more of the arms 86 of the pedal protector 82 can fit. As shown in FIGS. 4 and 7, multiple trashcans can be stacked within one another, with the pedal protector 82 of one trashcan facilitating a desired alignment of the trashcans within one other, and protecting the pedal 20 from damage. For example, when one trashcan 10′ is stacked within another trashcan 10 as shown in FIG. 4, the pedal protector 82′ of trashcan 10′ can prevent the pedal 20′ of trashcan 10′ from contacting other portions of the interior of the trashcan 10.

With continued reference to FIG. 4, in some embodiments the trashcan 10 can include a brow portion 88 which extends over the pedal 20. In such embodiments, an interior surface of the brow portion 88 can serve as a resting place for the pedal protector 82′ when the trashcan 10′ is nested within the trashcan 10.

With reference to FIG. 7, in some embodiments the pedal protector 82 can be flipped and/or rotated, to allow the pedal protector 82 to be moved away from the pedal 20. For example, the pedal protector 82 can be pivotably attached to the lower surface 84. The pedal protector 82 can rotate about a pivot portion or portions 89. This can allow a U-shaped pedal protector 82 to be flipped towards the other side of the trashcan 10, and for example to hide under lower surface 84. In some embodiments, flipping the pedal protector 82 away from the pedal 20 can facilitate easier stacking of one can within another for easier shipping, and/or allow more trashcans to be stacked within one another in a give volume of space.

With continued reference to FIGS. 5 and 7, a rear surface of the body 12 can further include a channel 90 configured to receive the lifting rod 22. As such, the lifting rod 22 can be better protected when the trashcan 10 is stacked within another trashcan. With reference to FIG. 4, the trashcan 10 can also include a rear projecting portion 92. The rear projecting portion 92 can help in protecting the lifting rod 22 when the trashcan 10 is stacked within another trash can. For example, the rear projecting portion 92, when the trashcan 10 is stacked within another trashcan, can contact an upper peripheral edge of the body 12 of another trashcan, thereby preventing any portion of the lifting rod 22 from contacting an upper peripheral edge of another trashcan.

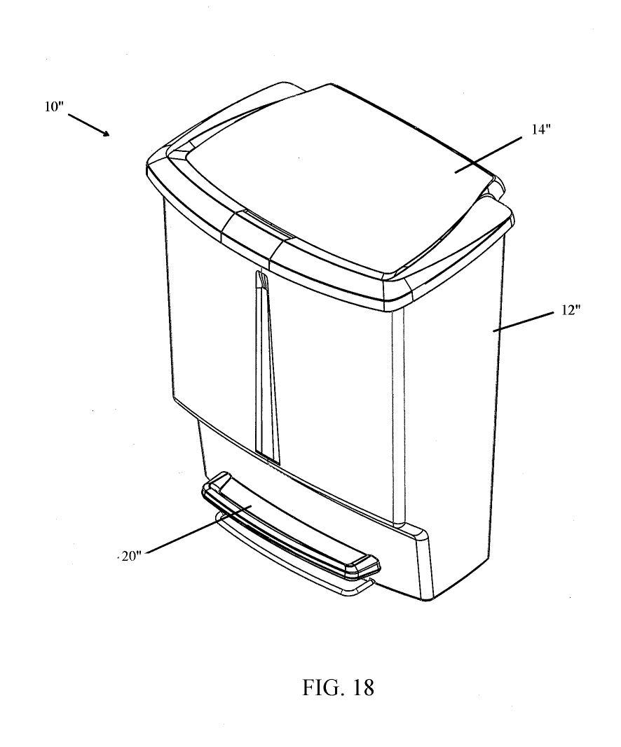

With reference to FIGS. 18-21, another embodiment of a trashcan 10″ is illustrated. The trashcan 10″ can include similar features of the trashcan 10 as described above. For example, the trashcan 10″ can include a body 12″, lid 14″, and a pedal 20″. The trashcan 10″ can be configured to hold at least one trash bag. For example, the trashcan 10″ can be configured to hold two trash bags separately from one another within the trashcan 10″.

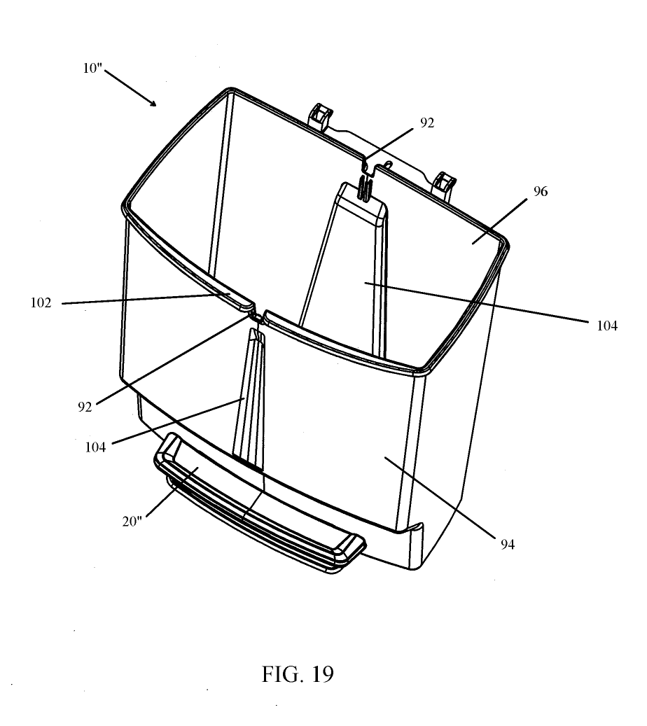

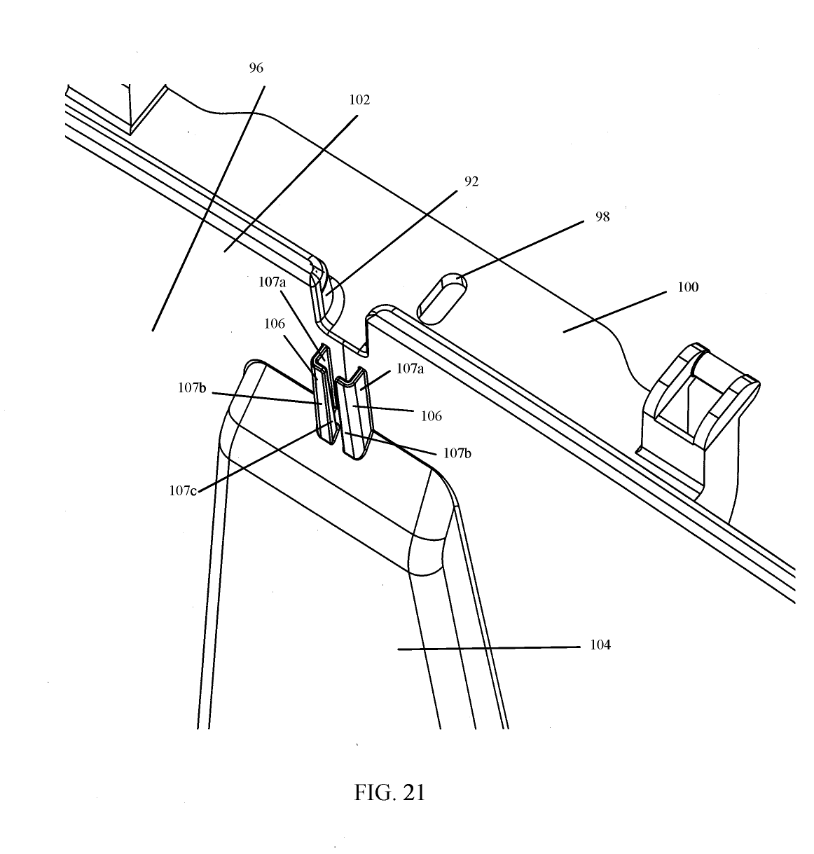

With reference to FIGS. 19-22, 26, and 28, the trashcan 10″ can comprise at least one notch 92 to facilitate insertion of at least one trash bag into the body 12″. For example, and with reference to FIG. 19, one notch 92 can be formed along a front wall 94 of the body 12. The notch can have a “U” shape, though other shapes are also possible. The trashcan 10″ can comprise at least one additional notch 92 along a back wall 96 of the trashcan 10″ as well, to further facilitate insertion of multiple trash bags. The notches 92 can facilitate insertion of more than one trash bag into the body 12″ of trashcan 10″, for example, by providing areas on the body 12 to wrap and/or secure the trash bags. In some embodiments, one trash bag can be used for recycling on one side of the trash can 10″, and another trash bag can be used for additional trash on the other side of the trashcan 10″. The notches 92 can be used to secure the trash bags, and to help divide the trash can 10″ into two or more compartments. With reference to FIG. 21, in some embodiments, an opening 98 can be formed near one of the notches 92. The opening 98 can be used, for example, as a bag tuck. In some embodiments, the opening 92 can be formed along a back ledge 100 of the body 12″. In some embodiments, the notches 92 can extend entirely through an upper portion 102 of body 12″.

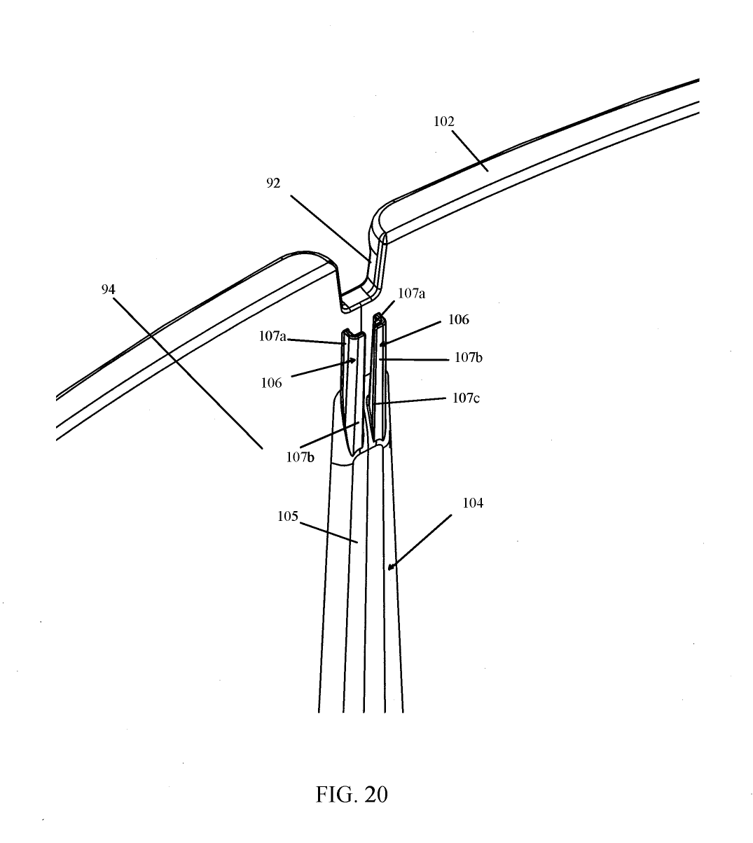

With continued reference to FIGS. 18-22, the trashcan 10″ can further comprise at least one support 104 in the body 12, which can optionally be in the form of an indentation. However, in some embodiments, the support 104 can be wholly within the interior of the body 12″ and thus not-visible on the outside of the body 12″. In some configurations, the support or “indentations” 104 can further facilitate a division of the trashcan 10″ into various compartments, and can help for example to separate two trash bags used for different purposes. In some embodiments, and with reference to FIG. 20, the support 104 can include a support surface 105. The support surface 105 can be flat, grooved, or have other contours. In some embodiments the support surface 105 can be configured to contact and/or align with an edge of a dividing type member within the trashcan 10″. In some embodiments the support surface 105 can support an edge of a dividing type member. For example, the support surface 105 can inhibit a dividing type member from twisting and/or torquing.

With continued reference to FIGS. 20 and 21, in some embodiments the trashcan 10″ can comprise at least one divider holding component 106. The dividers holding components 106 can, for example, be integrally formed or connected with the body 12″. The divider holding components 106 can be used to guide and/or hold a dividing type member within the cavity formed by the body 12″, so as to divide the trashcan 10″ into one or more compartments. The divider holding components 106 can be used to hold a diving type member in place. In some embodiments, the trashcan 10″ can include divider holding components 106 along an upper portion of the trashcan 10″, though additional, and/or other locations are also possible. In some embodiments the divider holding components 106 can have first walls 107a, second walls 107b, and lateral edges 107c. As illustrated in FIGS. 20 and 21, interior portions of the first walls 107a of two holding components 106 can face towards one another inside the trashcan 10″, interior portions of the second wall 107b can face towards the front or back walls 94, 96 of the trashcan 10″, and the lateral edges 107c of the components 106 can also face one another.

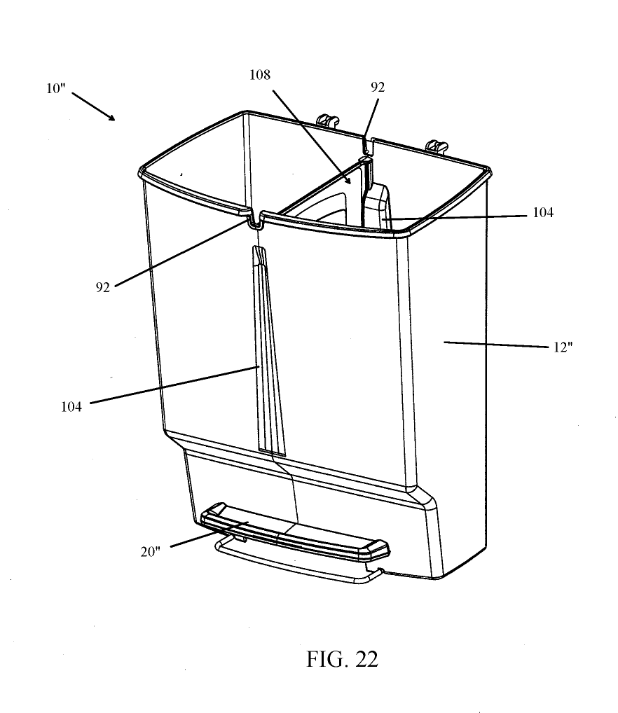

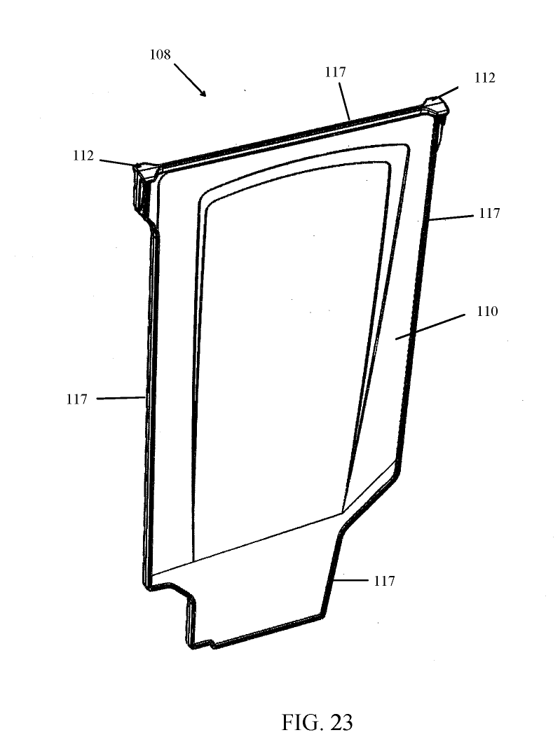

With reference to FIGS. 22-27, the trashcan 10″ can comprise at least one divider 108. As noted above, the divider 108 can be a dividing type member. The divider 108 can be inserted into the divider holding components 106, and can be used to divide the trashcan 10″ into one or more compartments. For example, the divider 108 can comprise a generally flat, dividing portion 110.

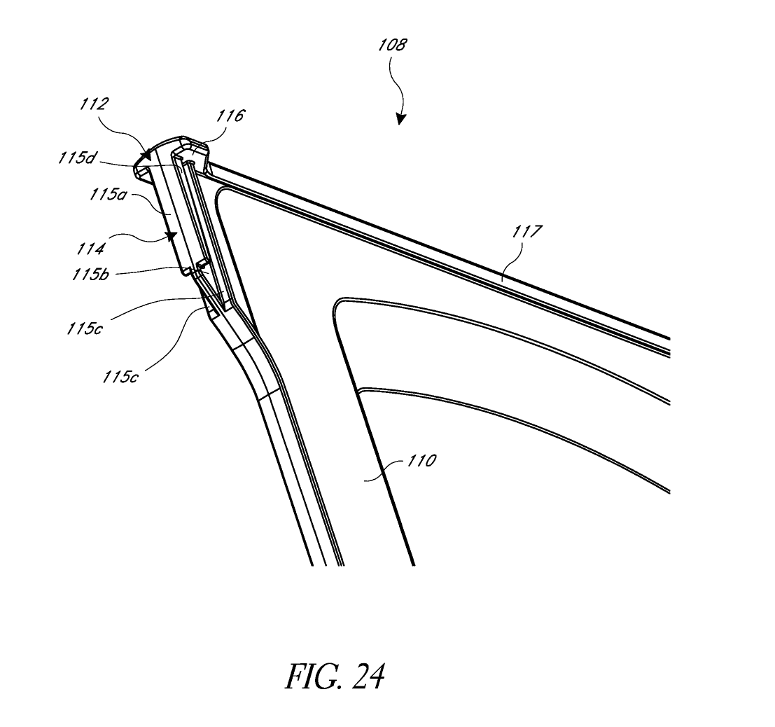

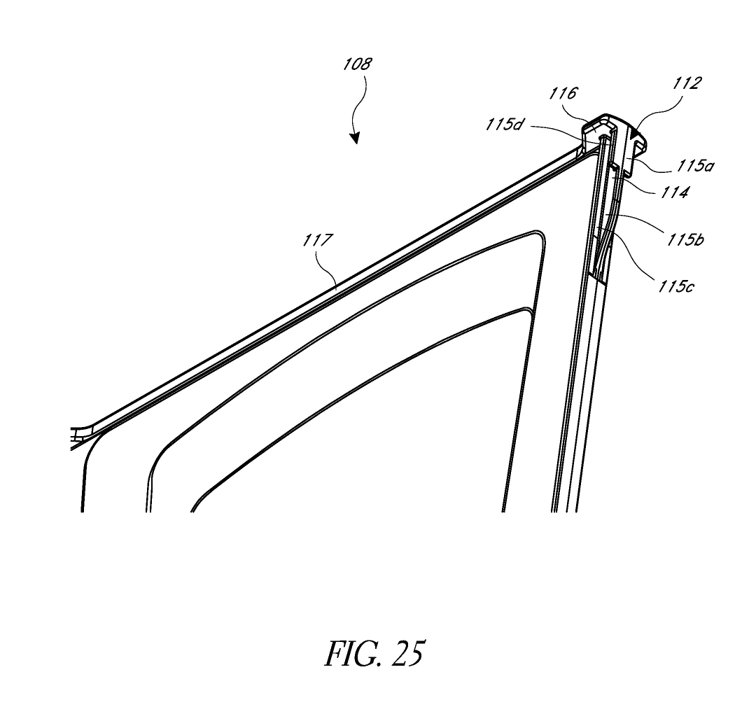

The divider 108 can further comprise at least one divider connection member 112. The divider connection member 112 can comprise an elongate member 114 that is configured to be received by the divider holding components 106. In some embodiments the elongate member 114 can form a generally I-beam-type shape. For example, and with reference to FIGS. 24 and 25, the elongate member 114 can include an outer flange 115a, a web 115b, and back flange surfaces 115c. In some embodiments the outer flange 115a can further include outer flange surfaces 115d.

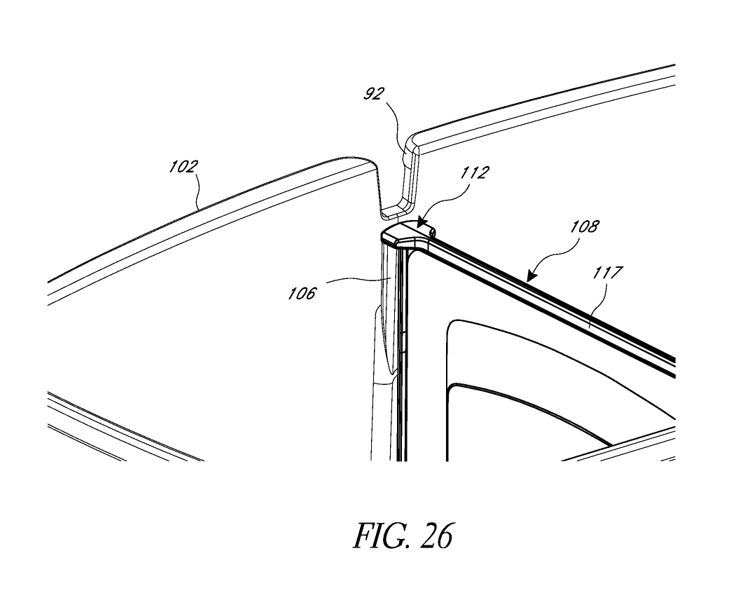

The divider 108 can further comprise at least one shoulder portion 116. The at least one shoulder portion 116 can extend from the at least one elongate member 114, and can be configured to rest on top of a divider holding component or components 106, so as to hold the divider 108 in place within the body 12″. For example, in some embodiments the shoulder portion 116 can rest on top of first and second walls 107a, 107b of the divider holding components 106, as illustrated for example in FIG. 26. In some embodiments, the shoulder portion 116 can be configured to be grabbed by a user (e.g. with a finger or fingers) and pulled directly upwards. Thus, the shoulder portion 116 can allow a user to pull the divider 108 vertically straight up out of a trashcan 10″, without causing any significant twisting, or torquing, of the divider 108 or trashcan 10″ while removing the divider 108. Pulling the divider 108 straight up out of the trashcan 10″ can advantageously inhibit damage to the divider 108 and/or trashcan 10″.

In some embodiments, one or more of the outer flange 115a, web 115b, back flange surfaces 115c, outer flange surfaces 115d, and shoulder portion 116 of a divider connection member 112 can contact one or more of the first wall 107a, second wall 107b, lateral edge 107c, and front or back walls 94, 96, to securely hold a divider 108 in place and/or inhibit twisiting and torquing of the divider 108 and/or trashcan 10″. For example, in some embodiments the outer flange 115a can contact the front or back wall 94, 96 of trashcan 10″. In some embodiments, the outer flange surfaces 115d can contact the first walls 107a of two divider holding components 106. In some embodiments, the web 115b can contact the lateral edges 107c of two divider holding components 106. In some embodiments, the back flange surfaces 115c can contact the second walls 107b of two divider holding components 106. In some embodiments, and as described above, the shoulder portion 116 can contact the top of first and/or second walls 107a, 107b of two divider holding components 106.

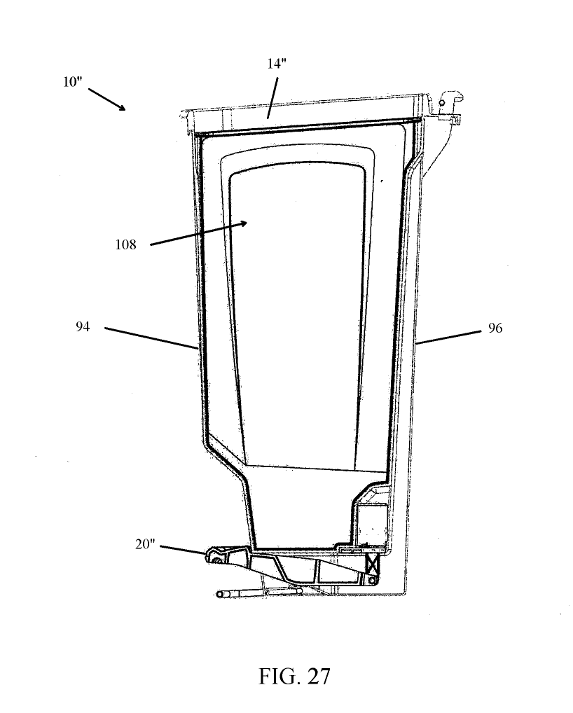

As illustrated in FIG. 27, the divider 108 can have a shape that is complimentary to the shape of the inside cavity formed by body 12″. For example, the divider 108 can be contoured and shaped such that it generally matches the shape of the inside of body 12″, thus leaving little or no spacing between the divider 108 and the front and back walls 94, 96, as well as the bottom of the trashcan 10″. Leaving little or no spacing can be advantageous if a trash bag, filled with trash, begins to push or strain against the divider 108. If there are large enough gaps, portions of the filled trash bag could begin to slide or bulge in one or more portions past the divider 108 into the other side of the trashcan 10″. This could lead to damage (e.g. tears) in the trash bag if a user tries to remove the trash bag from the trashcan 10″, and the trash bag becomes stuck.

In some embodiments, the divider 108 can include a divider lip 117 that extends at least partially around the divider 108. For example, the divider 108 can include a divider lip 117 that extends substantially or entirely around the divider 108. The divider lip 117 can be thicker and/or stiffer than most of the divider 108 (e.g. the remainder of the divider portion 110), so as to provide added stability to the divider 108 and inhibit unwated twisting or torquing of the divider 108. The lip 117 can inhibit a filled trash bag from pushing or bulging against the divider 108. In some embodiments, the divider lip 117 can rest against or contact a support 104 and/or support surface 105 of trashcan 10″.

The divider 108 can further be contoured and shaped such that it generally isolates one side of the interior cavity of trashcan 10″ from another side of the interior cavity of trashcan 10″. Such general isolation can facilitate one type of trash being collected on one side of the trashcan 10″ and another type of trash being collected on another side of the trashcan 10″.

Furthermore, and as illustrated for example in FIG. 22, the trashcan 10 can comprise a first notch 92 along an upper portion 102 of the body adjacent one end of the divider 108, and a second notch 92 along an upper portion 102 of the body adjacent another end of the divider 108. The first and second notches 92, along with the divider 108, can be configured to secure at least two trash bags inside the trashcan 10, and divide the trashcan 10″.

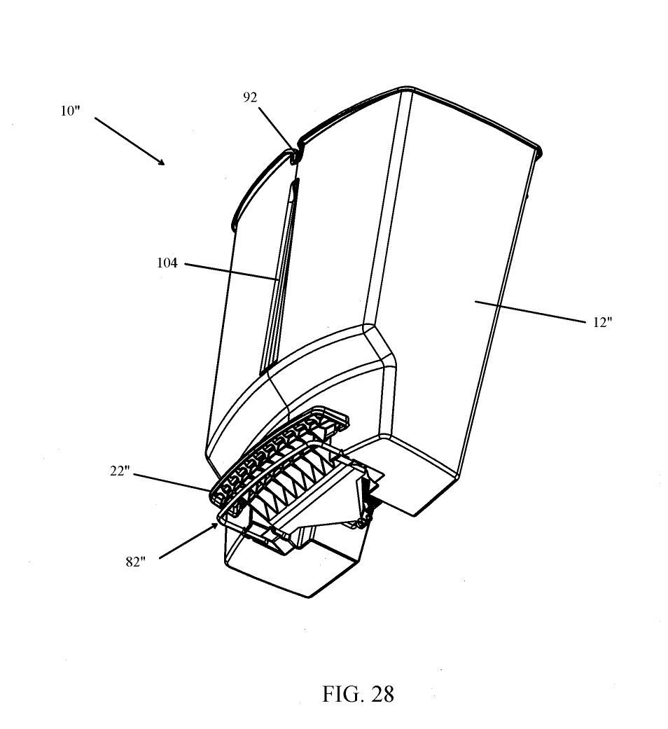

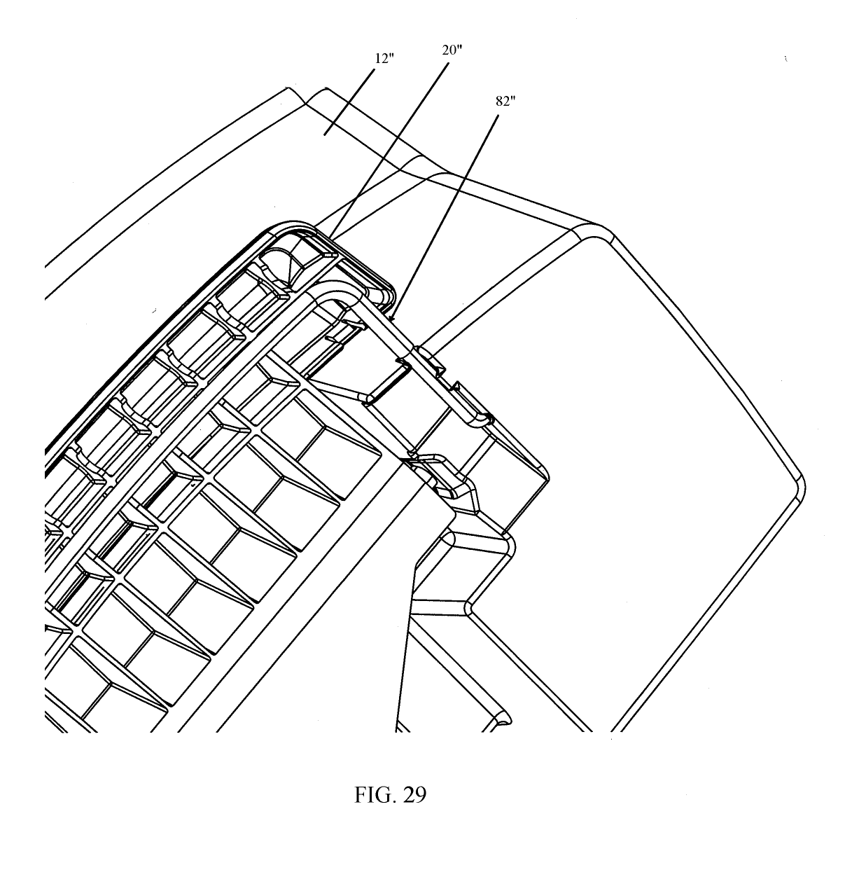

With reference to FIGS. 28-32, the trashcan 10″ can comprise a pedal protector 82″. The pedal protector 82″ can be similar to the pedal protector 82 described above. For example, the pedal protector 82″ can be pivotably connected to the trashcan 10″, and can be flipped for example from a first position adjacent a pedal 20″ to a second position away from pedal 20″.

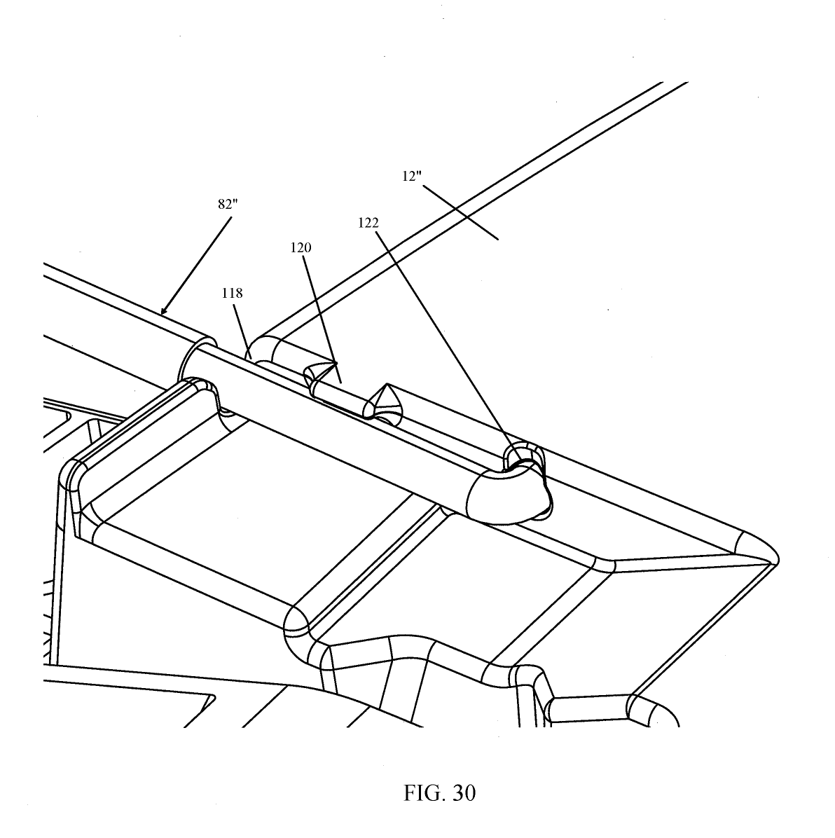

With reference to FIG. 30, in some embodiments the trashcan 10″ can comprise a groove or recess 118 along the body 12″. The groove or recess 118 can be configured to receive at least a portion of the pedal protector 82″. The body 12″ can further comprise a pedal protector retaining member 120. The pedal protector retaining member 120 can comprise, for example, a protrusion or protrusions. The pedal protector retaining member 120 can be configured to retain or hold the pedal protector 82″ in place, for example within the groove or recess 118. For example, the pedal protector 82″ can be moved such that it frictionally engages pedal protector retaining member 120, and/or slides past the pedal protector retaining member 116, thereby locking into the groove or recess 118.

With continued reference to FIGS. 30-32, the body 12″ can comprise an receptacle portion 122 that is configured to receive at least a portion of the pedal protector 82″ so as to provide pivotal mounting of the pedal protector 82″. For example, the receptacle can be in the form of an opening sized to receive a terminal end of the pedal protector 82″. However, other configurations can also be used.

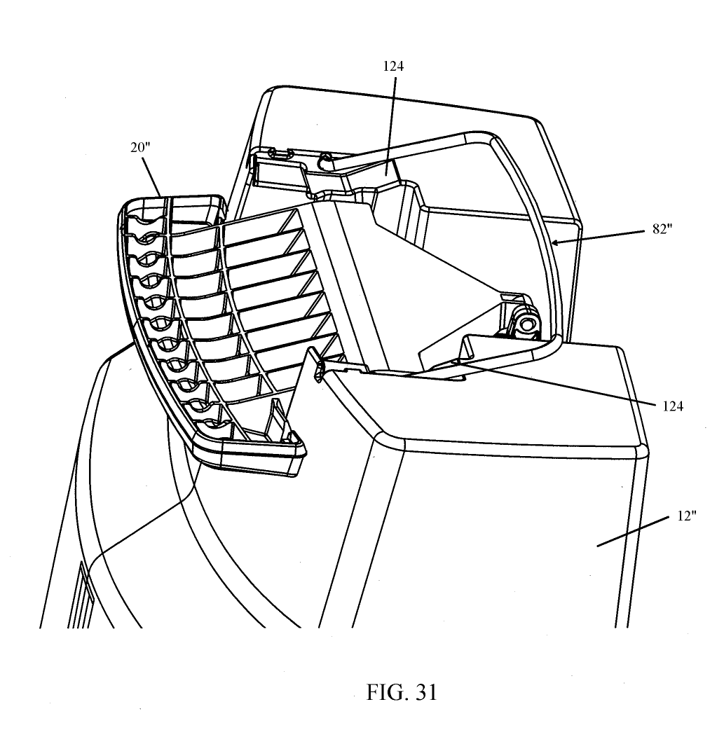

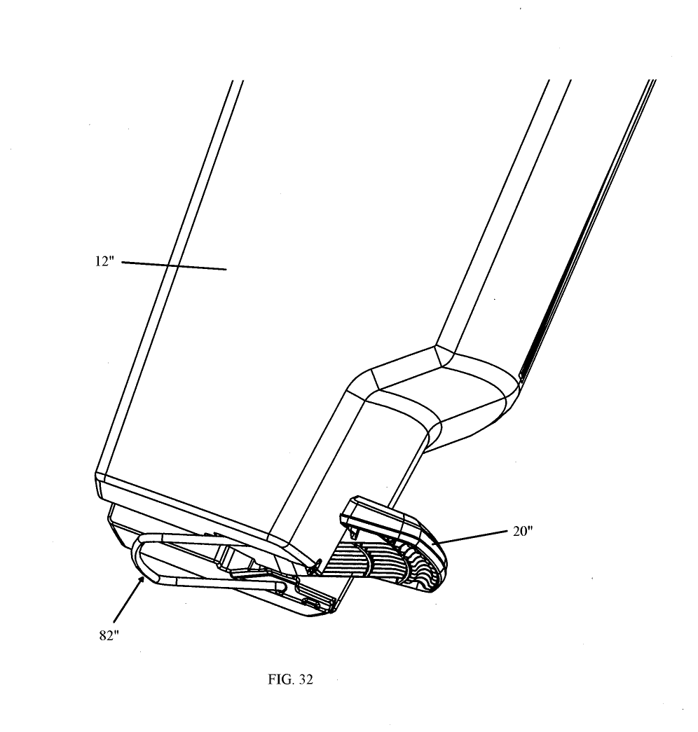

Pivotally mounted as such, the pedal protector 82″ can pivot in the area of the opening 122. For example, as illustrated in FIGS. 28-30, the pedal protector 82″ can be in a first position that is close to and beneath the pedal 20″, which can also be referred to as a “deployed” position. Further, and as illustrated in FIGS. 31 and 32, the pedal protector 82″ can pivot to a second position that is away from the pedal 20″, which can be referred to as a “stowed” position. For example, in the “stowed” position, the pedal protector 82″ be positioned within a periphery defined by the adjacent generally vertical walls of the body 12″. The pedal protector 82″ can rest, for example, against inclined portions 124 of the body 12″ in the second position. As described above, the pedal protector 82″ can be used as a stabilizing structure to inhibit or prevent the trashcan 10″ from being tipped over, and/or to prevent the pedal 20″ contacting or rubbing against the ground and becoming damaged or worn. Additionally or alternatively, the pedal protector 82″ can be moved to the first position, second position, or other position, so as to facilitate stacking of a plurality of trashcans 10″. For example, in some embodiments, flipping the pedal protector 82 away from the pedal 20 can facilitate easier stacking of one can within another for easier shipping, and/or allow more trashcans to be stacked within one another in a give volume of space.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments can be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A trashcan comprising:
a body defining an interior cavity configured to receive trash, the trash can body having at least one upper opening through which trash can be inserted into the interior cavity;
a lid pivotally attached to the trash can body so as to move between opened position and closed positions;
a lid actuating system comprising a pedal and at least one linkage connecting the pedal with the lid, such that movement of the pedal causes opening and closing movement of the lid;
a lid latch supported by the lid, the lid latch comprising a slidable member mounted so as to be slidable relative to the lid, the lid latch being slidable from a first position in which the lid latch engages a ledge of the trash can body so as to lock the lid in a closed position and a second position in which the lid latch does not engage the ledge of the trash can body;
a mounting platform connected to the body;
a damping mechanism connected to the mounting platform and to at least one of the linkages and pedal, the damping mechanism configured to dampen movement of the lid in at least one of an opening and closing motion;
at least one notch along the body for insertion of a trash bag;
a plurality of divider holding components located along the interior cavity;
a divider connected to the plurality of divider components, the divider dividing the interior cavity into a plurality of cavities for receiving trash; and
a pedal protector pivotably coupled to the body, the pedal protector configured to pivot from a first position near the pedal to a second position away from the pedal.

2. A trashcan comprising:
a body defining an interior cavity configured to receive trash, the trashcan body having at least one upper opening through which trash can be inserted into the interior cavity;
a lid pivotally attached to the trashcan body so as to move between opened position and closed positions;
a lid actuating system comprising a pedal and at least one linkage connecting the pedal with the lid, such that movement of the pedal causes opening and closing movement of the lid;
at least one notch along the body for insertion of a trash bag;
a plurality of divider holding components located along the interior cavity; and
a divider engaged with the plurality of divider components, the divider dividing the interior cavity into a plurality of cavities for receiving trash, the divider comprising a plurality of divider connection members having elongate members configured to be received within the divider holding components.

3. The trashcan of claim 2, wherein the elongate members comprise I-beam configurations.

4. The trashcan of claim 2, wherein the elongate members comprise outer flanges with outer flange surfaces, webs connected to the outer flanges, back flange surfaces connected to the webs, and wherein the divider connection member further comprises shoulder portions extending from the elongate structure.

5. The trashcan of claim 4, wherein the divider holding components comprise first walls, second walls connected to the first walls, and lateral edges along the second walls, and wherein one or more of the outer flanges, webs, back flange surfaces, outer flange surfaces, and shoulder portions of the divider connection members contact one or more of the first walls, second walls, and lateral edges of the divider holding components to hold the divider in place.

6. The trashcan of claim 5, wherein the plurality of divider holding components are integrally formed with the body.

7. The trashcan of claim 5, wherein the plurality of divider holding components are configured to guide and/or hold a divider within the interior cavity, and inhibit twisting and/or torquing of the divider.

8. The trashcan of claim 5, wherein the divider is configured to be inserted vertically into the divider holding components and trashcan, and wherein the shoulder portions are configured to be gripped by a user's fingers to remove the divider directly, and vertically, from the trashcan.

9. The trashcan of claim 2, wherein the divider comprises a divider lip that extends substantially entirely around the divider, the lip having a thickness greater than that of a majority of the divider, so as to provide the divider with greater stiffness in the lip.

10. The trashcan of claim 2, wherein the divider is secured in place in the trashcan by two divider components, one divider component along a front wall of the trashcan, and a second divider component along a back wall of the trashcan.

11. The trashcan of claim 2, wherein the divider generally takes the form of the inside cavity formed by body.

12. The trashcan of claim 11, wherein the divider is configured to isolate one side of the interior cavity of the trashcan from another side of the interior cavity of the trashcan.

13. The trashcan of claim 2, wherein the at least one notch comprises a first notch on a front wall of the trashcan, and a second notch on a back wall of the trash can, wherein both the first and second notches comprise generally U-shaped openings that extend entirely through an upper portion of the body.

14. The trashcan of claim 2, wherein the body further includes an opening along a back ledge of the body for securing at least one trash bag.

15. The trashcan of claim 2, wherein trashcan further comprises a first U-shaped notch along an upper portion of the body adjacent one end of the divider, and a second U-shaped notch along an upper portion of the body adjacent another end of the divider, the first and second U-shaped notches configured to be used to secure at least two trash bags inside the trashcan.

16. The trashcan of claim 2, wherein the trashcan is configured to receive two trash bags in the internal cavity, at least a portion of each of the trash bags wrapped around an upper portion of the body and at least one notch.

17. A trashcan comprising:
a body defining an interior cavity configured to receive trash, the trash can body having at least one upper opening through which trash can be inserted into the interior cavity;
a lid pivotally attached to the trash can body so as to move between opened position and closed positions;
a lid actuating system comprising a pedal and at least one linkage connecting the pedal with the lid, such that movement of the pedal causes opening and closing movement of the lid; and
a pedal protector pivotably attached to the body.

18. The trashcan of claim 17, wherein the trashcan further comprises a pedal attached to the body, wherein the pedal protector is pivotable from a first position adjacent the pedal to a second position away from the pedal.

19. The trashcan of claim 18, wherein the body comprises at least one inclined portion, wherein the pedal protector is configured to rest against the at least one inclined portion in the second position.

20. The trashcan of claim 17, wherein the trashcan further comprises a groove or recess along the body, the groove or recess configured to receive at least a portion of the pedal protector.

21. The trashcan of claim 20, wherein the body comprises a pedal protector retaining member configured to retain or hold the pedal protector in place within the groove or recess.

22. The trashcan of claim 17, wherein the body comprises an opening that receives at least a portion of the pedal protector, the pedal protector being configured to pivot in an area defined by the opening.

23. The trashcan of claim 17, wherein the pedal protector comprises arms that form a generally U-shaped pedal protector.

24. The trashcan of claim 17, wherein the pedal protector is configured to be positioned so as to inhibit a pedal of the trashcan from contacting a ground surface.

25. The trashcan of claim 17, wherein the pedal protector is configured to be positioned so as to provide a stabilizing force to the trashcan, thus inhibiting the trashcan from tipping over, and also to facilitate stacking of multiple trashcans.
